(19) United States
(12) Patent Application Publication
(10) Pub. No.: US 2025/0088846 A1
(43) Pub. Date: Mar. 13, 2025

(54) METHOD AND APPARATUS FOR PROTECTING INFORMATION TRANSMITTED AND RECEIVED ON USER PLANE IN WIRELESS COMMUNICATION SYSTEM

(71) Applicant: Samsung Electronics Co., Ltd., Gyeonggi-do (KR)

(72) Inventors: Taehyung LIM, Gyeonggi-do (KR); Duckey LEE, Gyeonggi-do (KR); Jungje SON, Gyeonggi-do (KR); Hongjin CHOI, Gyeonggi-do (KR)

(21) Appl. No.: 18/292,457

(22) PCT Filed: Aug. 11, 2022
(86) PCT No.: PCT/KR2022/012011

§ 371 Date: Jan. 26, 2024

(30) Foreign Application Priority Data
Aug. 12, 2021 (KR) 10-2021-0106944

(51) Int. Cl. H04W 12/041; H04W 12/10

(52) U.S. Cl. CPC H04W 12/041; H04W 12/10

(57) ABSTRACT

The disclosure relates to a fifth generation (5G) or sixth generation (6G) communication system for supporting a higher data transmission rate. The disclosure relates to a method and apparatus for enhancing security of a user plane in a communication system by improving security of a protection key to be used in the user plane. According to an embodiment of the disclosure, a method performed by a base station in a wireless network system includes generating, by a CU-CP or CU-UP included in the base station, a user plane protection key for integrity protection of at least one data or signaling transmitted and received in a user plane based on protection key generation information of the base station, transmitting, to a user equipment, protection key generation information of the user equipment for generating the user plane protection key, and applying the user plane protection key to the at least one data or signaling transmitted and received in the user equipment and the user plane.

### TECHNICAL FIELD

The disclosure relates to a wireless communication system, and more particularly, to a method and apparatus for enhancing security of a user plane in a communication system.

### BACKGROUND ART

5th generation (5G) mobile communication technologies define broad frequency bands such that high transmission rates and new services are possible, and can be implemented not only in “Sub 6GHz” bands such as 3.5 GHz, but also in “Above 6GHz” bands referred to as mmWave including 28 GHz and 39 GHz. In addition, it has been considered to implement 6th generation (6G) mobile communication technologies (referred to as beyond 5G system) in terahertz bands (e.g., 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices, the number of which have been exponentially increasing, will be connected to communication networks, and it is accordingly expected that enhanced functions and performance of 5G mobile communication systems and integrated operations of connected devices will be necessary. To this end, new research is scheduled in connection with extended reality (XR) for efficiently supporting AR, VR, MR and the like, 5G performance improvement and complexity reduction by utilizing artificial intelligence (AI) and machine learning (ML), AI service support, metaverse service support, and drone communication.

Furthermore, the development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Problem

An objective of the disclosure is to provide a method and apparatus for enhancing security of a user plane to remove threats to security that may occur in a communication system.

Technological objectives of the disclosure are not limited to what are mentioned above, and throughout the specification it will be clearly appreciated by those of ordinary skill in the art that there may be other technological objectives unmentioned.

### Technical Solution

According to an embodiment of the disclosure, a method performed by a base station (BS) in a wireless network system may be provided. The method may include identifying protection key generation information of the BS, generating, by a central unit-control plane (CU-CP) or a central unit-user plane (CU-UP) included in the BS, a user plane protection key including at least one of a first protection key for integrity protection of at least one data or signaling transmitted and received in a user plane, or a second protection key for encryption and decryption based on the protection key generation information of the BS, transmitting, to a user equipment (UE), protection key generation information of the UE for generating the user plane protection key based on the protection key generation information of the BS, and applying the user plane protection key to the at least one data or signaling transmitted and received in the UE and the user plane.

### DESCRIPTION OF DRAWINGS

FIG. 1 illustrates a network architecture for a fifth generation (5G) system, according to an embodiment of the disclosure.

FIG. 2 illustrates a network architecture for performing communication in a user plane, according to an embodiment of the disclosure.

FIGS. 3A, 3B and 3C are diagrams for describing a method of generating a protection key to be used in a user plane, according to an embodiment of the disclosure.

FIG. 4 illustrates a data transmission and reception flowchart in which a user equipment (UE) and a base station (BS) generate a protection key to be used in a user plane, according to an embodiment of the disclosure.

FIG. 5 is a flowchart for describing a method performed by a BS in a wireless network system, according to an embodiment of the disclosure.

FIG. 6 is a flowchart for describing a method performed by a UE in a wireless network system, according to an embodiment of the disclosure.

FIG. 7 is a diagram illustrating a configuration of a UE, according to an embodiment of the disclosure.

FIG. 8 is a diagram illustrating a configuration of a network entity, according to an embodiment of the disclosure.

FIG. 9 is a diagram illustrating a configuration of a BS, according to an embodiment of the disclosure.

### BEST MODE

According to an embodiment of the disclosure, a method performed by a base station (BS) in a wireless network system may be provided. The method may include identifying protection key generation information of the BS, generating, by a central unit-control plane (CU-CP) or a central unit-user plane (CU-UP) included in the BS, a user plane protection key including at least one of a first protection key for integrity protection of at least one data or signaling transmitted and received in a user plane, or a second protection key for encryption and decryption, based on the protection key generation information of the BS, transmitting, to a user equipment (UE), protection key generation information of the UE for generating the user plane protection key based on the protection key generation information of the BS, and applying the user plane protection key to the at least one data or signaling transmitted and received in the UE and the user plane.

According to an embodiment of the disclosure, a method performed by a UE in a wireless network system may be provided. The method may include receiving protection key generation information of the UE for generating a user plane protection key generated by a BS, based on protection key generation information of the BS; generating the user plane protection key including at least one of a first protection key for integrity protection of at least one data or signaling transmitted and received in a user plane, or a second protection key for encryption and decryption, based on the protection key generation information of the UE; and applying the user plane protection key to the at least one data or signaling transmitted and received in the BS and the user plane.

According to an embodiment of the disclosure, a BS performing in a wireless network system may be provided. The BS may include a transceiver and at least one processor, the at least one processor configured to identify protection key generation information of the BS, generate, by a CU-CP or a CU-UP included in the BS, a user plane protection key including at least one of a first protection key for integrity protection of at least one data or signaling transmitted and received in a user plane, or a second protection key for encryption and decryption, based on the protection key generation information of the BS, transmit, to a UE, protection key generation information of the UE for generating the user plane protection key, based on the protection key generation information of the BS, and apply the user plane protection key to the at least one data or signaling transmitted and received in the UE and the user plane.

According to an embodiment of the disclosure, a UE performing in a wireless network system may be provided. The UE may include a transceiver and at least one processor, the at least one processor configured to receive, from a BS, protection key generation information of the UE for generating a user plane protection key generated by the BS, based on protection key generation information of the BS, generate the user plane protection key including at least one of a first protection key for integrity protection of at least one data or signaling transmitted and received in a user plane, or a second protection key for encryption and decryption, based on the protection key generation information of the UE, and apply the user plane protection key to the at least one data or signaling transmitted and received in the BS and the user plane.

### Mode for Invention

Advantages and features of the disclosure, and methods for attaining them will be understood more clearly with reference to the following embodiments of the disclosure, which will be described in detail later along with the accompanying drawings. The embodiments of the disclosure may, however, be embodied in many different forms and should not be construed as limited to the embodiments set forth herein; rather, these embodiments of the disclosure are provided so that this disclosure will be thorough and complete, and will fully convey the scope of the embodiments of the disclosure to those of ordinary skill in the art. Like numbers refer to like elements throughout the specification.

It will be understood that each block and combination of the blocks of a flowchart may be performed by computer program instructions. The computer program instructions may be loaded on a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-executable or computer-readable memory that may direct the computers or other programmable data processing apparatus to function in a particular manner, such that the instructions stored in the computer-executable or computer-readable memory may produce an article of manufacture including instruction means that perform the functions specified in the flowchart blocks(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Furthermore, each block may represent a part of a module, segment, or code including one or more executable instructions to perform particular logic function(s). It is noted that the functions described in the blocks may occur out of order in some alternative embodiments. For example, two successive blocks may be performed substantially at the same time or the blocks may sometimes be executed in reverse order depending on the corresponding functions.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a smaller number of components and modules, or further divided into a larger number of components and modules. Moreover, the components and modules may be implemented to execute one or more central processing units (CPUs) in a device or security multimedia card. In embodiments, the module may include one or more processors.

Descriptions of some well-known technologies that possibly obscure the disclosure will be omitted, if necessary. Embodiments of the disclosure will now be described with reference to accompanying drawings.

Herein, terms to identify access nodes, terms to refer to network entities, terms to refer to messages, terms to refer to interfaces among network entities, terms to refer to various types of identification information, etc., are examples for convenience of explanation. Accordingly, the disclosure is not limited to the terms as herein used, and may use different terms to refer to the items having the same meaning in a technological sense.

Some of the terms and names defined by the 3rd generation partnership project (3GPP) long term evolution (LTE) will be used hereinafter. The disclosure is not, however, limited to the terms and definitions, and may equally apply to any systems that conform to other standards. In the disclosure, for convenience of explanation, eNode B (eNB) may be interchangeably used with gNode B (gNB). For example, a base station referred to as an eNB may also indicate a gNB. Furthermore, the term ‘terminal’ or ‘user equipment (UE)’ may refer not only to a cell phone, an NB-IoT device, and a sensor but also to other wireless communication devices.

In the following description, a base station is an entity for performing resource allocation for a terminal, and may be at least one of a gNB, an eNB, a Node B, a base station (BS), a radio access unit, a base station controller, or a network node. The terminal may include a UE, a mobile station (MS), a cellular phone, a smart phone, a computer, or a multimedia system capable of performing a communication function. It is, of course, not limited thereto.

Especially, the disclosure may be applied to the 3GPP new radio (NR) (which is the 5G mobile communication standard). The disclosure may be applied to intelligent services based on fifth generation (5G) communication and Internet of things (IoT) related technologies, e.g., smart homes, smart buildings, smart cities, smart cars, connected cars, health care, digital education, smart retail, and security and safety services. In the disclosure, evolved node B (eNB) may be interchangeably used with gNB. For example, a BS referred to as an eNB may also indicate a gNB. Furthermore, the term ‘terminal’ or ‘UE’ may refer not only to a cell phone, an NB-IoT device, and a sensor but also to other wireless communication devices.

Wireless communication systems are evolving from early systems that provide voice-oriented services to broadband wireless communication systems that provide high data rates and high quality packet data services such as 3GPP high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and IEEE 802.16e communication standards.

As a representative example of such a broadband wireless communication system, an LTE system adopts orthogonal frequency division multiplexing (OFDM) for a downlink (DL) and single carrier frequency division multiple access (SC-FDMA) for an uplink (UL). The UL refers to a radio link for a UE or MS to send data or a control signal to an eNode B or BS, and the DL refers to a radio link for a BS to send data or a control signal to a UE or MS. Such a multiple access scheme allocates and operates time-frequency resources for carrying data or control information for respective users not to overlap each other, i.e., to maintain orthogonality, thereby differentiating each user's data or control information.

As a future communication system after the LTE, the 5G communication system needs to freely reflect various demands from users and service providers and thus support services that simultaneously meet the various demands. The services considered for the 5G communication system may include enhanced Mobile Broadband (eMBB), massive Machine Type Communication (mMTC), Ultra Reliability Low Latency Communication (URLLC), etc.

In some embodiments, the eMBB is aimed at providing more enhanced data rates than the LTE, LTE-A or LTE-Pro may support. For example, in the 5G communication system, the eMBB is required to provide 20 Gbps peak data rate in DL and 10 Gbps peak data rate in UL in terms of a single BS. Furthermore, the 5G communication system may need to provide an increasing user perceived data rate while providing the peak data rate. To satisfy these requirements, enhancement of various technologies for transmission or reception including multiple-input multiple-output (MIMO) transmission technologies may be required in the 5G communication system. While the present LTE uses up to 20 MHz transmission bandwidth in the 2 GHz band for signal transmission, the 5G communication system may use frequency bandwidth wider than 20 MHz in the 3 to 6 GHz band or in the 6 GHz or higher band, thereby satisfying the data rate required by the 5G communication system.

At the same time, in the 5G communication system, mMTC is considered to support an application service such as an Internet of Things (IoT) application service. In order for the mMTC to provide the IoT efficiently, support for access from massive number of terminals in a cell, enhanced coverage of the terminal, extended battery time, reduction in terminal price, etc., may be required. Because the IoT is equipped in various sensors and devices to provide communication functions, it may be supposed to support a large number of UEs in a cell (e.g., 1,000,000 terminals/km²). Furthermore, a UE supporting the mMTC is more likely to be located in a shadow area, such as a basement of a building, which might not be covered by a cell due to the nature of the service, so the mMTC may require an even larger coverage than expected for other services provided by the 5G communication system. The UE supporting the mMTC needs to be a low-cost terminal, and may require quite a long battery life time such as 10 to 15 years because it is difficult to frequently change the battery in the UE.

Finally, the URLLC may be a mission-critical cellular based wireless communication service, which may be used for services used for remote control over robots or machinery, industrial automation, unmanned aerial vehicle, remote health care, emergency alert, etc. Accordingly, communication offered by the URLLC may require very low latency (ultra low latency) and very high reliability. For example, URLLC services may need to satisfy sub-millisecond (less than 0.5 millisecond) air interface latency and simultaneously may have a requirement for a packet error rate of 10⁻⁵ or less. Hence, for the URLLC services, the 5G system needs to provide a smaller transmit time interval (TTI) than for other services, and simultaneously requires a design that allocates a wide range of resources for a frequency band to secure reliability of the communication link.

Those three services considered in the aforementioned 5G communication system, i.e., eMBB, URLLC, and mMTC, may be multiplexed and transmitted from a single system. In this case, to meet different requirements for the three services, different transmission or reception schemes and parameters may be used between the services. The mMTC, URLLC, and eMBB are an example of different types of services, and embodiments of the disclosure are not limited to the service types.

Although the following embodiments of the disclosure will now be focused on an LTE, LTE-A, LTE Pro or 5G (or NR, next generation mobile communication) system for example, they may be equally applied to other communication systems with similar technical backgrounds or channel types. Furthermore, embodiments of the disclosure will also be applied to different communication systems with some modifications to such an extent that they do not significantly deviate from the scope of the disclosure when judged by those of ordinary skill in the art.

Embodiments of the disclosure will now be described in detail with reference to the accompanying drawings. In describing the disclosure, when it is determined that a detailed description of related known functions or features may unnecessarily obscure the subject matter of the disclosure, the detailed description will be omitted. Further, the terms, as will be mentioned later, are defined by taking functionalities in the disclosure into account, but may vary depending on practices or intentions of users or operators. Accordingly, the terms should be defined based on descriptions throughout this specification. Hereinafter, the BS is an entity for performing resource allocation for a UE, and may correspond to at least one of an eNode B (eNB), a Node B, a BS, a radio access network (RAN), an access network (AN), a RAN node, an NR NB, a gNB, a radio access unit, a base station controller, or a network node. The UE may include an MS, a cellular phone, a smart phone, a computer, or a multimedia system capable of performing communication functions. Herein, downlink (DL) refers to a radio transmission path for a signal transmitted from a BS to a UE, and uplink (UL) refers to a radio transmission path for a signal transmitted from a UE to a BS. Furthermore, although embodiments of the disclosure will now be focused on the LTE or LTE-A system as an example, they may be applied to other communication systems with similar technical backgrounds or channel types. Furthermore, embodiments of the disclosure will also be applied to other communication systems through some modifications to an extent that does not significantly deviate from the scope of the disclosure when judged by those skilled in the art.

In the meantime, the 3GPP in charge of standardization of cellular mobile communication has named a new core network architecture a 5G core (5GC) and proceeds with standardization to attempt evolution from the existing 4G LTE system to the 5G system.

The 5GC provides the following functions differentiated from a network core for the existing 4G, i.e., an evolved packet core (EPC).

First, a network slice function is introduced in the 5GC. As a requirement of 5G, the 5GC needs to support various UE types and services. For example, it may support eMBB, URLLC, and mMTC. The UE and the service each have a different requirement for the core network. For example, the eMBB service requires high data rates, and the URLLC service requires high reliability and low latency. A technology suggested to satisfy the various service requirements is a network slicing scheme.

Network slicing is a method of forming several logical networks by virtualizing one physical network, and each network slice instance (NSI) may have a different property. Hence, the various service requirements may be satisfied by each NSI having a network function (NF) that suits its property. Many 5G services may be efficiently supported by allocating an NSI that suits a property of a service required by each UE.

Secondly, the 5GC may easily support the network virtualization paradigm through separation between a mobility management function and a session management function. In the existing 4G LTE, all UEs may receive a service over a network by exchanging signals with a single core equipment called a mobility management entity (MME) that serves registration, authentication, mobility management and session management functions. On the other hand, in 5G, as the number of UEs is increasing explosively and mobility and traffic/session properties to be supported for each UE type have been subdivided, scalability to add an entity for each required function is bound to be lowered in a case that a single equipment such as the MME supports all the functions. Accordingly, various functions are being developed on a basis of a structure that separates between the mobility management function and the session management function to enhance scalability in terms of complexity in function/implementation of the core equipment that serves a control plane, and signaling load.

According to an embodiment of the disclosure, a method performed by a base station (BS) in a wireless network system may be provided. The method may include identifying protection key generation information of the BS, generating, by a central unit-control plane (CU-CP) or a central unit-user plane (CU-UP) included in the BS, a user plane protection key including at least one of a first protection key for integrity protection of at least one data or signaling transmitted and received in a user plane, or a second protection key for encryption and decryption, based on the protection key generation information of the BS, transmitting, to a UE, protection key generation information of the UE for generating the user plane protection key based on the protection key generation information of the BS, and applying the user plane protection key to the at least one data or signaling transmitted and received in the UE and the user plane.

According to an embodiment of the disclosure, a method performed by a UE in a wireless network system may be provided. The method may include receiving protection key generation information of the UE for generating a user plane protection key generated by a BS, based on protection key generation information of the BS, generating the user plane protection key including at least one of a first protection key for integrity protection of at least one data or signaling transmitted and received in a user plane, or a second protection key for encryption and decryption, based on the protection key generation information of the UE, and applying the user plane protection key to the at least one data or signaling transmitted and received in the BS and the user plane.

According to an embodiment of the disclosure, a BS performing in a wireless network system may be provided. The BS includes a transceiver and at least one processor, the at least one processor configured to identify protection key generation information of the BS, generate, by a CU-CP or a CU-UP included in the BS, a user plane protection key including at least one of a first protection key for integrity protection of at least one data or signaling transmitted and received in a user plane, or a second protection key for encryption and decryption, based on the protection key generation information of the BS, transmit, to a UE, protection key generation information of the UE for generating the user plane protection key, based on the protection key generation information of the BS, and apply the user plane protection key to the at least one data or signaling transmitted and received in the UE and the user plane.

It may include applying the user plane protection key.

According to an embodiment of the disclosure, a UE performing in a wireless network system may be provided. The UE includes a transceiver and at least one processor, the at least one processor configured to receive, from a BS, protection key generation information of the UE for generating a user plane protection key generated by the BS, based on protection key generation information of the BS, generate the user plane protection key including at least one of a first protection key for integrity protection of at least one data or signaling transmitted and received in a user plane, or a second protection key for encryption and decryption, based on the protection key generation information of the UE, and apply the user plane protection key to the at least one data or signaling transmitted and received in the BS and the user plane.

According to an embodiment of the disclosure, the UE and a gNB (gNB-CU-UP in particular) may generate a protection key for user plane which has enhanced security.

The effects according to the disclosure are not limited thereto, and throughout the specification it will be clearly appreciated by those of ordinary skill in the art that there may be other effects unmentioned.

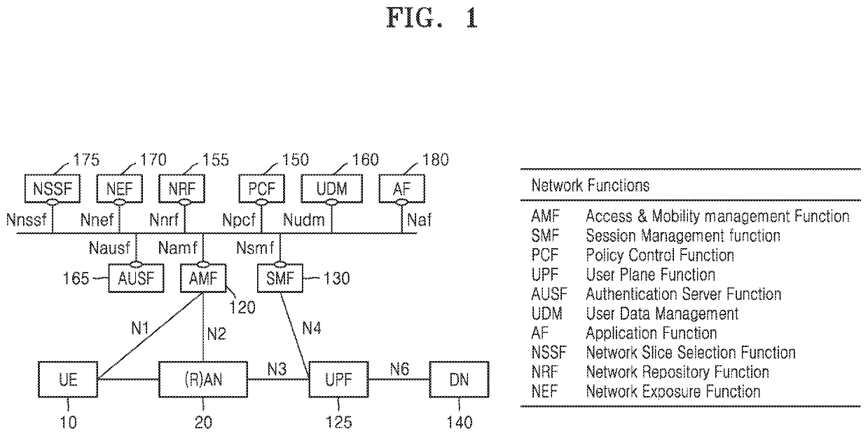

FIG. 1 illustrates a network architecture for a 5G system, according to an embodiment of the disclosure.

A unit for performing each function provided by the 5G network system may be defined as an NF. An architecture of a 5G mobile communication network is illustrated in FIG. 1. The NF may be implemented in a certain server or a network device. In the case that the NF is implemented in a certain server or a network device, two or more NFs may be installed in a single particular server (or network device). That the NF is installed may mean that the NF operates as a device that performs a network function. In the case that the NF is implemented in the server, two or more different NFs for performing the same function may be installed. The two or more different NFs may be NFs for controlling the same operation or may be different network functions.

A 5G core network may include an access and mobility management function (AMF) 120 that manages network access and mobility of a UE 10, a session management function (SMF) 130 that performs a function related to a session in relation to the UE, a user plane function (UPF) 125 that serves transfer of user data and is controlled by the SMF, an application function (AF) 180 that communicates with a 5GC for provision, a network exposure function (NEF) 170 that supports communication between the 5GC and the AF 180, a unified data management (UDM) 160 and a unified data repository (UDR) (not shown) that store and manage data, a policy and control function (PCF) 150 that manages a policy, and a data network (DN) 140 such as the Internet over which user data is delivered. Furthermore, for the 5G mobile communication network, there may be an operation, administration and management (OAM) (not shown), which is a system for managing UEs and the 5G mobile communication network in addition to the NFs. Session information may include quality of service (QOS) information, charging information, information about packet processing, etc. The 5G network system may further include a radio access network 20 (or a BS), an authentication server function (AUSF) 165, a network slice selection function (NSSF) 175 and a network repository function (NRF) 155.

Referring to FIG. 1, the UE 10 may be a terminal that is able to access the 5G network. The UE 10 may also use other radio access schemes to access various networks such as a 4G network and/or a wireless fidelity (Wi-Fi) network. Furthermore, the UE 10 may have various types. For example, the UE 10 may be implemented as a terminal that provides only IoT functions, implemented in such a type as a smart phone or a tablet computer, or implemented as a wearable device such as a smart watch or smart glasses. The disclosure is not limited to special types of the UE 10.

A radio access node (RAN) 20 may correspond to a network node for transmitting or receiving a signal or data in the air to or from the UE 10 in a 5G radio access scheme. The (R)AN 20 may be a general term of a new radio access network that supports both evolved universal terrestrial radio access (E-UTRA), evolved version of a 4G radio access technology, and new radio (NR), e.g., gNB.

The UPF 110 may forward a downlink protocol data unit (PDU) received from the DN 115 to the UE 10 via a (R)AN 20, and forward an uplink PDU received from the UE 10 to the DN 115 via the (R)AN 20. Specifically, the UPF 110 may support functions of QoS handling (e.g., packet filtering, gating, uplink/downlink rate enforcement), uplink traffic verification (service data flow (SDF) mapping between an SDF and a QoS flow), transport-level packet marking in uplink and downlink, downlink packet buffering. downlink data notification triggering, etc., for a user plane, an anchor point for intra/inter radio access technology (RAT) mobility, an external PDU session point of interconnection to a DN, a user plane part for packet routing and forwarding, packet inspection and policy rule enforcement, an uplink classifier for lawful intercept, traffic use reporting, traffic flow routing to a DN, and a branch point for supporting a multi-home PDU session.

Through the 5G core network illustrated in FIG. 1 as described above, the UE 10 may receive a service such as 5G network access and data transmission or reception. Furthermore, the 5G core network may perform communication between the NFs to manage the UE 10.

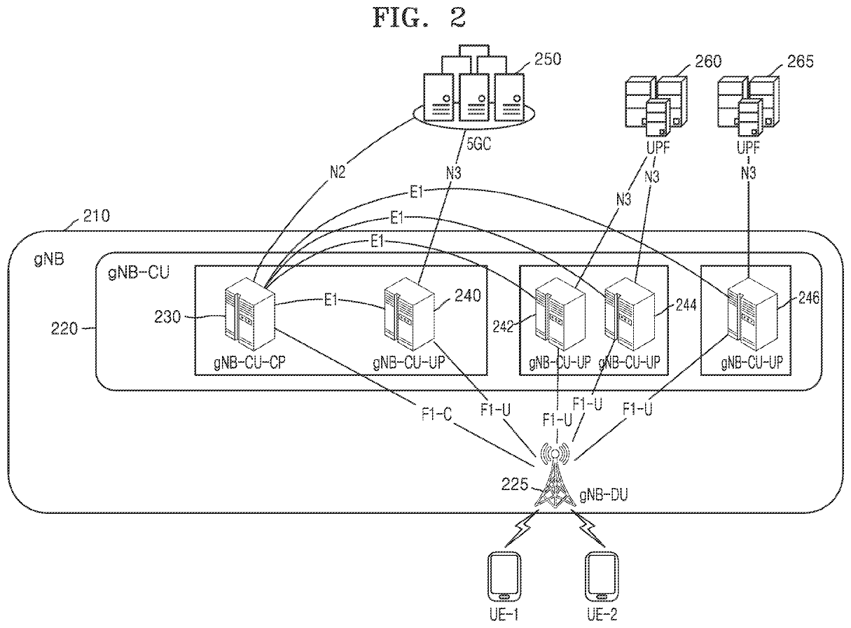

FIG. 2 illustrates a network architecture for performing communication in a user plane, according to an embodiment of the disclosure.

A 5GC shown in FIG. 2 may include all and/or part of the NFs shown in FIG. 1 except the UE 10 and the RAN 20.

A gNB 210 shown in FIG. 2 may refer to the RAN 20 shown in FIG. 1.

The gNB 210 may include a gNB-CU 220 and a gNB-DU 225. The gNB-CU 220 may refer to a central unit among elements that make up the function of the gNB 210, and may be a logical node for hosting radio resource control (RRC), service data adaptation protocol (SDAP) and packet data convergence protocol (PDCP) layers of the gNB 210. The gNB-DU 225 may refer to a distributed unit among the elements that make up the function of the gNB 210, and may be a logical node for hosting radio link control (RLC), media access control (MAC) and physical (PHY) layers of the gNB 210.

The gNB-CU 220 may include a gNB-CU-CP 230 and gNB-CU-UPs 240, 242, 244 and 246. The gNB-CU-CP 230 may refer to a unit that serves transmission and reception of signaling and/or data related to a control plane among elements that make up the function of the gNB-CU 220, and may be a logical node for hosting RRC and PDCP-C protocols. The gNB-CU-UP 240, 242, 244 and 246 may refer to units that serve transmission and reception of signaling and/or data related to a user plane among the elements that make up the function of the gNB-CU 220, and may be a logical node for hosting a PDCP-U protocol.

In the disclosure, signaling may refer to control information and data may refer to information (e.g., user data) other than the control information.

The gNB-CU 220 shown in FIG. 2 may include one or more gNB-CU-UPs 240, 242, 244 and 246.

The gNB-CU-CP 230 shown in FIG. 2 may be connected to a 5GC 260 through an N2 interface. As shown in FIG. 1, the gNB-CU-CP 230 may be connected to the AMF 125 through an N2 interface.

The gNB-CU-UP 240 shown in FIG. 2 may be connected to a UPF of the 5GC 250 through an N3 interface, the gNB-CU-UPs 242 and 242 may be connected to a UPF 260 through the N3 interface, and the gNB-CU-UP 244 may be connected to a UPF 265 through the N3 interface. As shown in FIG. 1, the gNB-CU-UPs 240, 242, 244 and 246 may be connected to the UPF 110 through the N3 interface.

The gNB-CU-CP 230 may be connected to the gNB-DU 225 through an F1-C interface. The gNB-CU-UPs 240, 242, 244 and 246 may be connected to the gNB-DU 225 through an F1-U interface.

The gNB-CU-CP 230 and the gNB-CU-UPs 240, 242, 244 and 246 as shown in FIG. 2 may be connected through an E1 interface.

When the UE 10 communicates with the RAN 20 (or the gNB 210) to transmit and receive signaling and/or data in a user plane, the signaling and/or data transmitted and received in the user plane may need to be protected for security. For security, the signaling and/or data in the user plane may be protected by being performed integrity-protection to guarantee integrity of the message and encryption/decryption to guarantee confidentiality of the message.

For security of the signaling and/or data in the user plane, the UE 10 and the gNB 210 (gNB-CU-UPs 240, 242, 244 and 246 in particular) need to share a protection key to be used in the user plane. Each gNB-CU-UP 240, 242, 244 or 246 may communicate with the UE 10 by using various PDU sessions and/or data radio bearers (DRBs). In a case that each gNB-CU-UP 240, 242, 244 or 246 and the UE 10 uses the same single protection key to transmit and receive the signaling and/or data in the user plane, a leakage of at least one protection key has the same effect as exposure of all the protection keys, causing threats to security.

Hence, the disclosure provides a method of enhancing security of the user plane to remove the threats to security. For example, the disclosure may provide a method by which each gNB-CU-UP 240, 242, 244 or 246 generates and uses a different protection key. Furthermore, the disclosure may provide a method of generating and using the protection key that varies by each gNB-CU-UP 240, 242, 244 or 246. Moreover, the disclosure may provide a method of generating and using a different protection key depending on the session used by each gNB-CU-UP 240, 242, 244 or 246 and the UE 10. According to an embodiment of the disclosure, the UE 10 and the gNB 210 may generate a protection key differentiated by at least one of intention of use, subject of use, or purpose of use. Furthermore, as the UE 10 in communication with the gNB 210 may generate the same protection key as a protection key used by the gNB 210, the UE 10 and the gNB 210 may share the same protection key. Hence, even when one protection key is leaked, another protection key is securely protected, thereby increasing the security level of the user plane.

A method and apparatus for enhancing security of the user plane in a communication system by improving security of a protection key to be used in the user plane will now be described in more detail in connection with drawings as will be mentioned below.

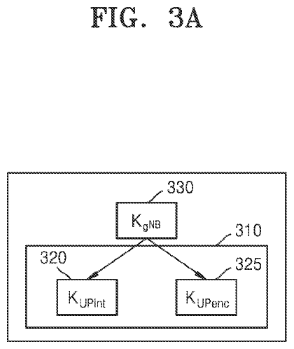

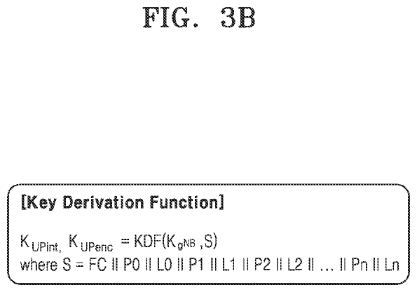

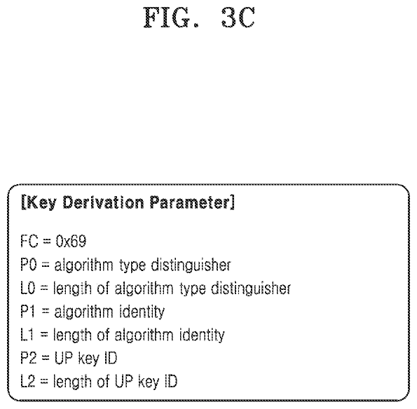

FIGS. 3A, 3B and 3C are diagrams for describing a method of generating a protection key to be used in a user plane, according to an embodiment of the disclosure.

Referring to FIG. 3A, a protection key 310 to be used in a user plane used when the UE 10 and the gNB 210 transmit and receive signaling and/or data in the user plane will be described.

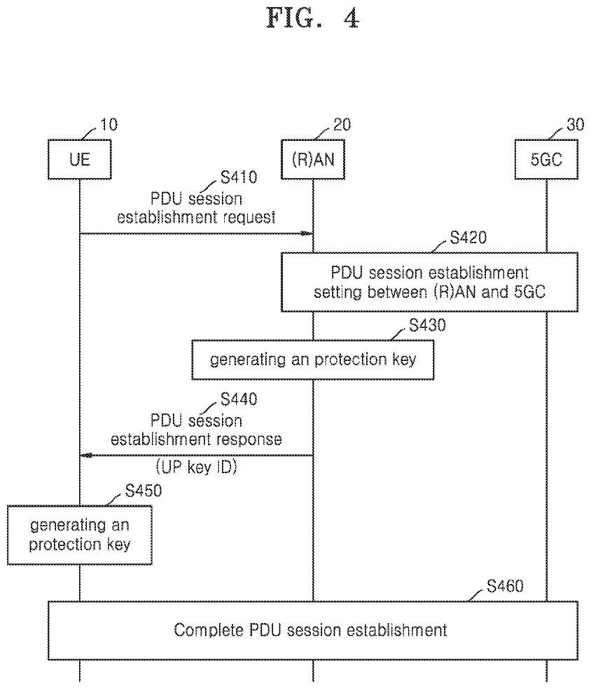

The gNB 210 (or RAN 20) and the UE 10 may generate the protection key 310 to be used in the user plane (hereinafter, a protection key may refer to the protection key to be used in the user plane). When the gNB 210 generates the protection key 310, detailed operations of sub-units (e.g., the gNB-CU-CP 230 and/or the gNB-CU-UPs 240, 242, 244 and 246) of the gNB 210 shown in FIG. 2 will be described in more detail in connection with FIG. 4.

The protection key 310 to be used in the user plane may include K_{UPint} 320 used for integrity protection of signaling and/or data transmitted and received in the user plane. The protection key 310 to be used in the user plane may include K_{UPenc} 325 used for encryption and decryption of signaling and/or data transmitted and received in the user plane.

The protection key 310 to be used in the user plane, K_{UPint} 320 and/or K_{UPenc} 325 may be derived from a root key K_{gNB} 330. A more detailed deriving procedure will be described in connection with FIG. 3B.

K_{gNB} 330 may be shared between the gNB 220 and the UE 10 before the protection key 310 to be used in the user plane is generated. K_{gNB} 330 may have been generated in an authentication procedure (e.g., primary authentication procedure) of the communication network.

In an embodiment, the UE 10 and the RAN 20 may each generate the protection key 310 to be used in the user plane. For example, the gNB-CU-CP 230, the gNB-CU-UP 240 or the UE 10 may generate the protection key 310 to be used in the user plane by using a method of generating a protection key to be used in a user plane as will be described in connection with FIGS. 3B and 3C.

Referring to FIG. 3B, a method by which the UE 10 and the gNB 210 generate the protection key 310 will be described.

Referring to FIG. 3B, the protection key 310 to be used in the user plane, K_{UPint} 320 and/or K_{UPenc} 325 may be derived by putting the following two inputs to a key derivation function (KDF). In an embodiment, the UE 10 or the RAN 20 may generate the protection key 310 to be used in the user plane by using the KDF.
input key: K_{gNB} 330
input string: S

The KDF according to an embodiment of the disclosure may be any KDF that derives a new key by receiving inputs of a key and a string. As a non-limited example, the KDF may be a keyed-hash message authentication code or hash-based message authentication code (HMAC) function that forms a message authentication code (MAC) by using a hash function. The hash function may be any hash function that generates a hash value by receiving an input of any character string. As a non-limited example, the hash function may be an SHA-256 function.

The input string S according to an embodiment of the disclosure may be configured in various ways. Although a method of generating the string S by concatenating FC, P0, L0, P1, L1, . . . , Pn and Ln values is shown in FIG. 3B as an example, it is not limited thereto. Detailed meaning of FC, P0, L0, P1, L1, . . . , Pn and Ln shown in FIG. 3B will be provided with reference to FIG. 3C.

Referring to FIG. 3C, information used when the UE 10 and the gNB 210 generates the protection key 310 will be described.

Referring to FIG. 3C, the string S shown in FIG. 3B may be configured by concatenating three types of values as will be described below. How to configure the S by concatenating the following three types of values will be described with reference to FIG. 3B.
FC
Pn, where n is a natural number starting from 0.
Ln, where n is a natural number starting from 0.

FC may be any value. For example, FC may have a value of 0×69 as shown in FIG. 3C.

Pn may be a value including various information, and Ln may be a value representing length of Pn.

Information (i.e., values to be put into Pn) indicated by Pn according to an embodiment will be described later. However, the values to be inserted to Pn are not limited to the following embodiment. In other words, part and/or whole of the following embodiment may be used, and other information that will not be described below may be added. Furthermore, a sequence of the values as shown in the following embodiment is not limited to what will be described below but may have any sequence.
P0: an algorithm type distinguisher. A factor indicating whether a protection key to be derived is K_{UPint} 320 or K_{UPenc} 325.
P1: An algorithm identity. A type of an algorithm to be used to generate a protection key. (e.g., SNOW 3G, advanced encryption standard (AES), zuc stream cipher (ZUC), etc.)
P2: UP key ID. Identifier (ID) of the protection key 310 to be used in the user plane.

The UP key ID as described for an example of P2 may refer to information used to specify the protection key 310 to be used in the user plane. The UP key ID may include one of various values (or information) as will be suggested below. The UP key ID is not, however, limited to one of the following examples. In other words, the UP key ID may be any information that may specify the protection key 310 to be used in the user plane.
Key index: An index value of a key (e.g., a natural number)
Nonce (e.g., any random value)
DRB ID (an ID of a DRB to which a signal and/or data to be transmitted and received in the user plane belongs)
PDU session ID (an ID of a PDU session to which a signal and/or data to be transmitted and received in the user plane belongs)
UP ID (an ID of a gNB-CU-UP to communicate with the UE to transmit and receive a user-plane signal and/or data)

When P2 according to an embodiment includes information about the UP key ID, L2 may include information about length of the UP key ID.

Using the aforementioned method, the RAN 20 (e.g., the gNB-CU-CP 230 or the gNB-CU-UP 240) and the UE 10 may generate the protection key 310 to be used in the user plane. Operations of the RAN 20 (e.g., the gNB-CU-CP 230 or the gNB-CU-UP 240) and the UE 10 will be described in detail in connection with the drawings as will be described below.

FIG. 4 illustrates a data transmission and reception flowchart in which a UE and a BS generate a protection key to be used in a user plane, according to an embodiment of the disclosure.

Referring to FIG. 4, for the UE 10 and the RAN 20 to generate, share and use the protection key 310 to be used in the user plane, a method of transmitting and receiving data between the UE 10, the RAN 20 and a 5GC 30 and a method of operating them according to an embodiment of the disclosure will be described. Although the gNB 210 may have multiple gNB-CU-UPs, operations of FIG. 4 will be described by focusing on the single gNB-CU-UP 240 for convenience of explanation.

In operation S410, the UE 10 may transmit a PDU session establishment request message to the RAN 20 (which may herein refer to a gNB). For example, in operation S410, the gNB-CU 220 may receive the PDU session establishment request message from the UE 10. In another example, the gNB-CU-CP 230 may receive the PDU session establishment request message from the UE 10. In another example, the gNB-CU-UP 240 may receive the PDU session establishment request message from the UE 10.

The PDU session establishment request message may include a PDU session ID generated by the UE 10, without being limited to thereto.

In operation S420, the RAN 20 and the 5GC 30 may transmit and receive signaling and/or data to establish a PDU session. NFs included in the RAN 20 and the 5GC 30 may be described by referring to descriptions of FIGS. 1 and 2.

To establish the PDU session, the RAN 20 and the 5GC 30 may perform at least one of the following operations. For example, the gNB-CU 220 may perform operations of the RAN 20 as will be described below. In another example, the gNB-CU-CP 230 may perform operations of the RAN 20 as will be described below.
the RAN 20 may transmit, to the AMF 120, the PDU session establishment request message received from the UE 10.
the AMF 120 may select the SMF 130 and transmit, to the SMF 130, a message requesting a new establishment of the PDU session or update of the existing PDU session.
the SMF 130 may obtain subscription information of the UE 10 required to establish the PDU session through communication with the UDM 160.
the SMF 130 may select and communicate with the PCF 150 to obtain policy information to establish the PDU session.
the SMF 130 may select the UPF 125 and perform, with the selected UPF 125, a series of procedures for a preparation process for establishing the PDU session.
the SMF 130 may transmit, to the AMF 120, information required to establish the PDU session.
the AMF 120 may transmit, to the RAN 20, information required to establish the PDU session.

In operation S430, the RAN 20 may generate a protection key to be used in the user plane.

In an embodiment of the disclosure, the RAN 20 may generate the protection key 310 to be used in the user plane for protection or encrypted communication of the UE 10 and the RAN 20. The RAN 20 may use the method of generating the protection key 310 to be used in the user plane as described above in connection with FIGS. 3A, 3B and 3C to generate the protection key 310 to be used in the user plane for encrypted communication. In operation S430, the gNB-CU-UP 240 may generate or obtain the protection key to be used in the user plane.

In an embodiment of the disclosure, the RAN 20 may generate and/or obtain the protection key to be used in the user plane by performing one of the following methods.

In an embodiment, the gNB-CU-CP 230 may generate the protection key 310 to be used in the user plane. Referring to FIGS. 3A, 3B and 3C, the gNB-CU-CP 230 may generate the protection key 310 to be used in the user plane based on at least one of K_{gNB} 330, the algorithm type distinguisher, the algorithm ID, or the UP key ID. As a non-limited example, the UP key ID may be at least one of a key index, nonce, a DRB ID, a PDU session ID, a UP ID or any information that may specify the protection key 310 to be used in the user plane. Afterward, the gNB-CU-CP 230 may transmit the generated protection key 310 to be used in the user plane to the gNB-CU-UP 240 to subsequently communicate with the user plane (UP). In this case, the gNB-CU-CP 230 may transmit, to the gNB-CU-UP 240, at least one of an ID of the PDU session or a list (e.g., DRB IDs) of DRBs to be used by the gNB-CU-UP 240 along with the protection key 310 to be used in the user plane.

In an embodiment, the gNB-CU-CP 230 may transmit, to the gNB-CU-UP 240, information for generating the protection key 310 to be used in the user plane. For example, the information for generating the protection key to be used in the user plane may include at least one of K_{gNB} 330, the algorithm type distinguisher, the algorithm ID, or the UP key ID. As a non-limited example, the UP key ID may be at least one of a key index, nonce, a DRB ID, a PDU session ID, a UP ID or any information that may specify the protection key 310 to be used in the user plane. The gNB-CU-UP 240 may generate the protection key 310 to be used in the user plane based on the information for generating the protection key, received from the gNB-CU-CP 230. In this case, the gNB-CU-CP 230 may transmit at least one of an ID of the PDU session or a list (e.g., DRB IDs) of DRBs to be used by the gNB-CU-UP 240 along with the information for generating the protection key to be used in the user plane.

Operation S430 is described as being performed after operation S420 in FIG. 4, but the sequence of performing operations S430 and S420 is not limited to that described in FIG. 4. Specifically, operation S430 may be performed before operation S420, during operation S420, or after operation $420.

In operation S440, the RAN 20 may transmit a PDU session establishment response message to the UE 10. For example, the gNB-CU 220 may transmit the PDU session establishment response message to the UE 10. In another example, the gNB-CU-CP 230 may transmit the PDU session establishment response message to the UE 10.

In an embodiment of the disclosure, the RAN 20 may transmit, to the UE 10, information required to generate the protection key 310 to be used in the user plane, so that the UE 10 may generate the protection key 310 to be used in the user plane for protection or encrypted communication of the UE 10 and the RAN 20.

For example, the information required to generate the protection key 310 to be used in the user plane and delivered to the UE 10 from the RAN 20 may be transmitted in the PDU session establishment response message. For example, the information required to generate the protection key 310 to be used in the user plane and delivered to the UE 10 from the RAN 20 may be delivered in a separate message from the PDU session establishment response message.

In an embodiment, the information required for the UE 10 to generate the protection key 310 and transmitted to the UE 10 from the RAN 20 may include the UP key ID (an ID of the protection key 310 to be used in the user plane). As a non-limited example, the UP key ID may be at least one of a key index, nonce, a DRB ID, a PDU session ID, a UP ID or any information that may specify the protection key 310 to be used in the user plane.

In an embodiment, the information required for the UE 10 to generate the protection key 310 and transmitted to the UE 10 from the RAN 20 may include at least one of an ID of a PDU session or a list (e.g., DRB IDs) of DRBs to be used by the UE 10.

In an embodiment, the information required for the UE 10 to generate the protection key 310 and transmitted to the UE 10 from the RAN 20 may include at least one of K_{gNB} 330, the algorithm type distinguisher or the algorithm identity.

In operation S450, the UE 10 may generate a protection key to be used in the user plane.

In an embodiment of the disclosure, the UE 10 may generate the protection key 310 to be used in the user plane based on the information received in operation S440 and required for generating the protection key to be used in the user plane.

For example, referring to FIGS. 3A, 3B and 3C, the UE 10 may generate the protection key 310 to be used in the user plane based on at least one of K_{gNB} 330, the algorithm type distinguisher, the algorithm ID, or the UP key ID.

In operation S460, the UE 10 and the RAN 20 may complete establishment of the PDU session.

For example, in operation S460, the UE 10, the RAN 20 and the 5GC 30 may perform a procedure for finishing the PDU session establishment.

The procedure for finishing the PDU session establishment may include one or more of the following operations. The following operation of the RAN 20 may be performed by the gNB-CU 220. The following operation of the RAN 20 may be performed by the gNB-CU-CP 220.
the RAN 20 may transmit, to the AMF 120, a message for finishing the PDU session establishment.
the AMF 120 may perform the procedure for finishing the PDU session establishment with the SMF 130. In this case, the SMF 130 may further perform the procedure for finishing the PDU session establishment with the UPF 125.
the SMF 130 may provide information relating to the established PDU session to the UDM 160.

For example, in operation S460, the UE 10 and the RAN 20 may use the user plane to transmit and receive signaling and/or data. The signaling and/or data transmitted and received by the UE 10 and the RAN 20 using the user plane may be protected by the protection key 310 generated in operations S430 and S450. For example, the gNB-CU 220 or the gNB-CU-UP 240 may use the protection key 310 generated or obtained in operation S430 to perform at least one of integrity protection or encryption on the signaling and/or data to be transmitted to the UE 10. Furthermore, the gNB-CU 220 or the gNB-CU-UP 240 may use the protection key 310 generated or obtained in operation S430 to perform at least one of integrity check or decryption on the signaling and/or data received from the UE 10. For example, the UE 10 may use the protection key 310 generated in operation S450 to perform at least one of integrity protection or encryption on the signaling and/or data to be transmitted to the gNB 210. Furthermore, the UE 10 may use the protection key 310 generated in operation S450 to perform at least one of integrity check or decryption on the signaling and/or data received from the gNB 210.

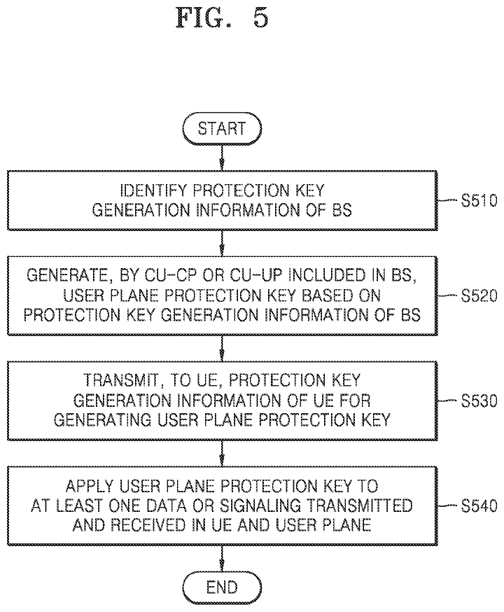

FIG. 5 is a flowchart for describing a method performed by a BS in a wireless network system, according to an embodiment of the disclosure.

Descriptions overlapping with what are described above in FIGS. 3A, 3B, 3C and 4 will be omitted. A user plane protection key, which will be described below, may refer to the aforementioned protection key 310 to be used in the user plane.

In an embodiment of the disclosure, the user-plane protection key may include at least one of a first protection key for integrity protection of at least one data or signaling transmitted and received in the user plane, or a second protection key for encryption and decryption.

In operation S510, the BS may identify protection key generation information of the BS.

In an embodiment of the disclosure, the protection key generation information of the BS may include at least one information of a root key (e.g., K_{gNB} 330), an algorithm type distinguisher indicating a type of the user-plane protection key, identification information of an algorithm for generating the protection key, or identification information of the user plane protection key.

In an embodiment of the disclosure, the identification information of the user plane protection key may include at least one of an index value of the protection key, a random value, identification information of the PDU session, (identification) information of the DRB or identification information of a CU-UP. As a non-limited example, the identification information of the user plane protection key may correspond to one of an index value of the protection key, a random value, identification information of the PDU session, (identification) information of the DRB or identification information of a CU-UP.

In an embodiment of the disclosure, the identification information of the user plane protection key may be generated based on at least one of the index value of the protection key, the random value, identification information of the PDU session, (identification) information of the DRB or identification information of the CU-UP.

In operation S520, the BS may generate the user plane protection key by a CU-CP or a CU-UP included in the BS, based on the protection key generation information of the BS.

In an embodiment of the disclosure, the BS may generate the user plane protection key by the CU-CP based on the protection key generation information of the BS. Furthermore, the BS may transmit, by the CU-CP, the user plane protection key to the CU-UP.

In an embodiment of the disclosure, the BS may transmit, by the CU-CP, the protection key generation information of the BS to the CU-UP. Moreover, the BS may generate, by the CU-UP, the user plane protection key based on the protection key generation information of the BS.

In operation S530, the BS may transmit, to the UE, protection key generation information of the UE for generating the user plane protection key.

In an embodiment of the disclosure, the BS may generate protection key generation information of the UE based on the protection key generation information of the BS. For example, the protection key generation information of the UE may include at least one information of a root key (e.g., K_{gNB} 330), an algorithm type distinguisher indicating a type of the user-plane protection key, identification information of an algorithm for generating the protection key, or identification information of the user-plane protection key.

In operation S540, the BS may apply the user plane protection key to the at least one data or signaling transmitted and received in the UE and the user plane.

In an embodiment of the disclosure, the BS may receive a PDU session establishment request from the UE. The BS may transmit, to the UE, a PDU session establishment response based on the PDU session establishment request. For example, the protection key generation information of the BS may be identified based on at least one of the PDU session establishment request, BS configuration information, or information about the PDU session. For example, the PDU session establishment response may include the protection key generation information of the UE to be transmitted to the UE.

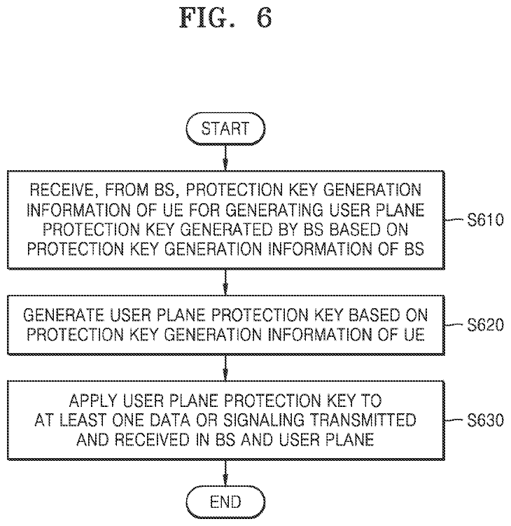

FIG. 6 is a flowchart for describing a method performed by a UE in a wireless network system, according to an embodiment of the disclosure.

Descriptions overlapping with what are described above in FIGS. 3A, 3B, 3C and 4 will be omitted. A user-plane protection key, which will be described below, may refer to the protection key 310 to be used in the aforementioned user plane.

In an embodiment of the disclosure, the user plane protection key may include at least one of a first protection key for integrity protection of at least one data or signaling transmitted and received in the user plane, or a second protection key for encryption and decryption.

In operation S610, the UE may receive, from the BS, the protection key generation information of the UE for generating the user plane protection key generated by the BS based on the protection key generation information of the BS.

In an embodiment of the disclosure, the protection key generation information of the BS may include at least one information of a root key (e.g., K_{gNB} 330), an algorithm type distinguisher indicating a type of the user-plane protection key, identification information of an algorithm for generating the protection key, or identification information of the user plane protection key.

In an embodiment of the disclosure, the protection key generation information of the UE may be generated based on the protection key generation information of the BS. For example, the protection key generation information of the UE may include at least one of a root key, an algorithm type distinguisher indicating a type of the user-plane protection key, identification information of an algorithm for generating the protection key, or identification information of the user plane protection key.

In an embodiment of the disclosure, the identification information of the user plane protection key may include at least one of an index value of the protection key, a random value, identification information of the PDU session, (identification) information of the DRB or identification information of a CU-UP. As a non-limited example, the identification information of the user plane protection key may correspond to one of an index value of the protection key, a random value, identification information of the PDU session, (identification) information of the DRB or identification information of a CU-UP.

In an embodiment of the disclosure, the identification information of the user plane protection key may be generated based on one of the index value of the protection key, the random value, identification information of the PDU session, information of the DRB or identification information of the CU-UP.

In an embodiment of the disclosure, the user plane protection key generated by the BS may be generated by the CU-CP included in the BS based on the protection key generation information. Furthermore, the user plane protection key generated by the BS may be transmitted by the CU-CP to the CU-UP included in the BS.

In an embodiment of the disclosure, the protection key generation information may be transmitted by the CU-CP included in the BS to the CU-UP included in the BS. Furthermore, the user plane protection key generated by the BS may be generated by the CU-UP based on the protection key generation information.

In operation S620, the UE may generate the user plane protection key based on the protection key generation information of the UE.

In operation S630, the UE may apply the user plane protection key to at least one data or signaling transmitted and received in the BS and the user plane.

In an embodiment of the disclosure, the UE may transmit a PDU session establishment request to the BS. The UE may receive, from the BS, a PDU session establishment response based on the PDU session establishment request. For example, the protection key generation information may be identified based on at least one of the PDU session establishment request, BS configuration information, or information about the PDU session. For example, the PDU session establishment response may include the protection key generation information received from the BS.

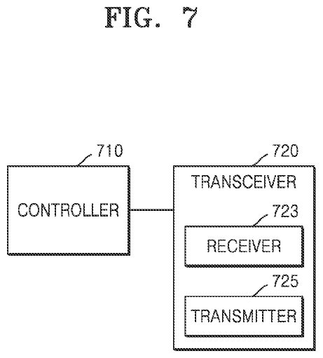

FIG. 7 is a diagram illustrating a configuration of a UE, according to an embodiment of the disclosure.

Referring to FIG. 7, a UE according to an embodiment of the disclosure may include a transceiver 720 and a controller 710 for controlling general operation of the UE. The transceiver 720 may include a transmitter 725 and a receiver 723.

The transceiver 720 may transmit or receive signals to or from other network entities.

The controller 710 may control the UE to perform operations of one of the aforementioned embodiments. In the meantime, the controller 710 and the transceiver 720 may not always implemented as separate modules but may also be integrated in a unit having the form of a single chip. The controller 710 and the transceiver 720 may be electrically connected to each other. For example, the controller 710 may be a circuit, an application-specific integrated circuit or at least one processor. Operations of the UE may be implemented by program codes stored in a memory device equipped in the UE.

In an embodiment of the disclosure, the at least one processor may receive, from the BS, the protection key generation information of the UE for generating the user plane protection key generated by the BS based on the protection key generation information of the BS. The at least one processor may generate the user plane protection key including at least one of a first protection key for integrity protection of at least one data or signaling transmitted and received in the user plane, or a second protection key for encryption and decryption, based on the protection key generation information of the UE. The at least one processor may apply the user plane protection key to the at least one data or signaling transmitted and received in the BS and the user plane.

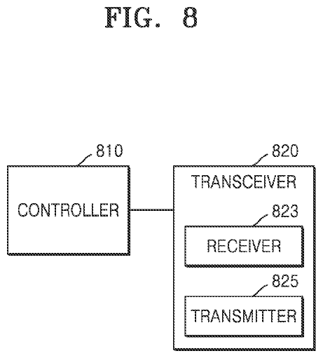

FIG. 8 is a diagram illustrating a configuration of a network entity, according to an embodiment of the disclosure.

The network entity of the disclosure is a concept including an NF according to a system implementation.

Referring to FIG. 8, the network entity according to an embodiment of the disclosure may include a transceiver 820 and a controller 810 for controlling general operation of the network entity. The transceiver 820 may include a transmitter 825 and a receiver 823.

The transceiver 820 may transmit or receive signals to or from other network entities.

The controller 810 may control the network entity to perform operations of one of the aforementioned embodiments. In the meantime, the controller 810 and the transceiver 820 may not always implemented as separate modules but may also be integrated in a unit having the form of a single chip. The controller 810 and the transceiver 820 may be electrically connected to each other. For example, the controller 810 may be a circuit, an application-specific integrated circuit or at least one processor. Operations of the network entity may be implemented by program codes stored in a memory device equipped in the network entity.

The network entity may be one of the BS (RAN) 20, AMF, SMF, UPF, PCF, NF, NEF, NRF, NSSF, UDM, UDR, AF, DN, AUSF. SCP, UDSF, context storage, OAM, element management system (EMS), AAA-P and AAA-H.

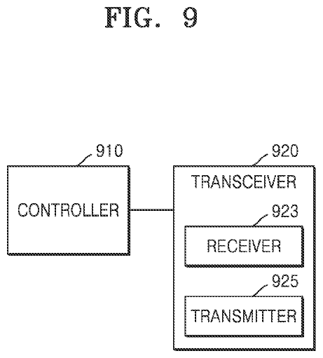

FIG. 9 is a diagram illustrating a configuration of a BS, according to an embodiment of the disclosure.

Referring to FIG. 9, a BS according to an embodiment of the disclosure may include a transceiver 920 and a controller 910 for controlling general operation of the BS. The transceiver 920 may include a transmitter 921 and a receiver 923.

The transceiver 920 may transmit or receive signals to or from other BS, UE, or network entities.

The controller 910 may control the BS to perform operations of one of the aforementioned embodiments. In the meantime, the controller 910 and the transceiver 820 may not always implemented as separate modules but may also be integrated in a unit having the form of a single chip. The controller 810 and the transceiver 820 may be electrically connected to each other. For example, the controller 810 may be a circuit, an application-specific integrated circuit or at least one processor. Operations of the BS may be implemented by program codes stored in a memory device equipped in the BS.

In an embodiment of the disclosure, at least one processor may identify protection key generation information of the BS. The at least one processor may generate, by a CU-CP or a CU-UP included in the BS, a user plane protection key including at least one of a first protection key for integrity protection of at least one data or signaling transmitted and received in a user plane, or a second protection key for encryption and decryption, based on the protection key generation information of the BS. The at least one processor may transmit, to the UE, the protection key generation information of the UE for generating the user plane protection key, and apply the user plane protection key to at least one data or signaling transmitted or received in the UE and the user plane.

It should be noted that the aforementioned block diagrams, illustrations of control/data signal transmission and reception methods, and illustrations of operation procedures are not intended to limit the scope of the disclosure. In this respect, all the components, entities or operations illustrated in FIGS. 1 to 9 should not be interpreted as essential elements to practice the disclosure, but may be implemented with some of the elements within the scope of the disclosure.

The aforementioned operations of the base station or the UE may be implemented by program codes stored in a storage equipped in the base station or the UE. In other words, the controller of the base station or the UE may perform the aforementioned operations by reading out and executing the program codes with a processor or a central processing unit (CPU).

Various components and modules of the entity, base station or UE may be implemented in hardware such as complementary metal oxide semiconductor (CMOS)-based logic circuits, firmware, software embedded in a machine-readable medium, and/or a combination thereof. For example, various electrical structures and methods may be practiced using electrical circuits such as transistors, logic gates, and application specific integrated circuits (ASICs).

Several embodiments of the disclosure have thus been described, but it will be understood that various modifications can be made without departing the scope of the disclosure. Thus, it will be apparent to those of ordinary skill in the art that the disclosure is not limited to the embodiments described, but can encompass not only the appended claims but the equivalents.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a machine-readable storage medium (e.g., a compact disc read only memory (CD-ROM)) or distributed directly between two user devices (e.g., smart phones) or online (e.g., downloaded or uploaded). In the case of the online distribution, at least part of the computer program product (e.g., a downloadable app) may be at least temporarily stored or arbitrarily created in a storage medium that may be readable to a device such as a server of the manufacturer, a server of the application store, or a relay server.

1. A method performed by a base station (BS) in a wireless network system, the method comprising:
identifying protection key generation information of the BS;
generating, by a central unit-control plane (CU-CP) or a central unit-user plane (CU-UP) included in the BS, a user plane protection key including at least one of a first protection key for integrity protection of at least one data or signaling transmitted and received in a user plane, or a second protection key for encryption and decryption based on the protection key generation information of the BS;
transmitting, to a user equipment (UE), protection key generation information of the UE for generating the user plane protection key; and
applying the user plane protection key to the at least one data or signaling transmitted and received in the UE and the user plane.

2. The method of claim 1, wherein:
the protection key generation information of the BS comprises at least one of a root key, an algorithm type distinguisher indicating a type of the user plane protection key, identification information of an algorithm for generating the protection key, or identification information of the user plane protection key, and
the identification information of the user plane protection key comprises at least one of an index value of the protection key, a random value, identification information of a protocol data unit (PDU) session, information of a data radio bearer (DRB), or identification information of the CU-UP.

3. The method of claim 1, further comprising generating the protection key generation information of the UE based on the protection key generation information of the BS,
wherein the protection key generation information of the UE comprises at least one of a root key, an algorithm type distinguisher indicating a type of the user plane protection key, identification information of an algorithm for generating the protection key, or identification information of the user plane protection key.

4. The method of claim 1, wherein the generating of the user plane protection key based on the protection key generation information of the BS comprises:
generating, by the CU-CP, the user plane protection key based on the protection key generation information of the BS; and
transmitting, by the CU-CP, the user plane protection key to the CU-UP.

5. The method of claim 1, wherein the generating of the user plane protection key based on the protection key generation information of the BS comprises:
transmitting, by the CU-CP, the protection key generation information of the BS to the CU-UP; and
generating, by the CU-UP, the user plane protection key based on the protection key generation information of the BS.

6. The method of claim 1, further comprising:
receiving, from the UE, a PDU session establishment request; and
transmitting, to the UE, a PDU session establishment response based on the PDU session establishment request,
wherein the protection key generation information of the BS is identified based on at least one of the PDU session establishment request, BS configuration information, or information about a PDU session, and
wherein the PDU session establishment response comprises the protection key generation information of the UE.

7. A method performed by a user equipment (UE) in a wireless network system, the method comprising:
receiving, from a base station (BS), protection key generation information of the UE for generating a user plane protection key generated by the BS based on protection key generation information of the BS;
generating the user plane protection key including at least one of a first protection key for integrity protection of at least one data or signaling transmitted and received in a user plane, or a second protection key for encryption and decryption, based on the protection key generation information of the UE; and
applying the user plane protection key to the at least one data or signaling transmitted and received in the BS and the user plane.

8. The method of claim 7, wherein the protection key generation information of the BS comprises at least one of a root key, an algorithm type distinguisher indicating a type of the user plane protection key, identification information of an algorithm for generating the protection key, or identification information of the user plane protection key.

9. The method of claim 7, wherein:
the protection key generation information of the UE is generated based on the protection key generation information of the BS,
the protection key generation information of the UE comprises at least one of a root key, an algorithm type distinguisher indicating a type of the user plane protection key, identification information of an algorithm for generating the protection key, or identification information of the user plane protection key, and
the identification information of the user plane protection key comprises at least one of an index value of the protection key, a random value, identification information of a protocol data unit (PDU) session, information of a data radio bearer (DRB), or identification information of the central unit-user plane (CU-UP).

10. The method of claim 7, wherein:
the user plane protection key generated by the BS is generated by a central unit-control plane (CU-CP) included in the BS based on the protection key generation information of the BS, and
transmitted to a central unit-user plane (CU-UP) included in the BS.

11. The method of claim 7, wherein:
the protection key generation information of the BS is transmitted by a central unit-control plane (CU-CP) included in the BS to a CU-UP included in the BS, and the user plane protection key generated by the BS is generated by the CU-UP based on the protection key generation information of the BS.

12. The method of claim 7, further comprising:
transmitting, to the BS, a PDU session establishment request; and
receiving, from the BS, a PDU session establishment response based on the PDU session establishment request,
wherein the protection key generation information of the BS is identified based on at least one of the PDU session establishment request, BS configuration information, or information about the PDU session, and
wherein the PDU session establishment response comprises the protection key generation information of the UE.

13. A base station (BS) performing in a wireless network system, the BS comprising:
a transceiver; and
at least one processor,
wherein the at least one processor is configured to:
identify protection key generation information of the BS,
generate, by a central unit-control plane (CU-CP) or a central unit-user plane (CU-UP) included in the BS, a user plane protection key including at least one of a first protection key for integrity protection of at least one data or signaling transmitted and received in a user plane, or a second protection key for encryption and decryption, based on the protection key generation information of the BS,
transmit, to a user equipment (UE), protection key generation information of the UE for generating the user plane protection key, and
apply the user plane protection key to the at least one data or signaling transmitted and received in the UE and the user plane.

14. The BS of claim 13, wherein:
the protection key generation information of the BS comprises at least one of a root key, an algorithm type distinguisher indicating a type of the user plane protection key, identification information of an algorithm for generating the protection key, or identification information of the user plane protection key, and
the identification information of the user plane protection key comprises at least one of an index value of the protection key, a random value, identification information of a protocol data unit (PDU) session, information of a data radio bearer (DRB) or identification information of the CU-UP.

15. The BS of claim 13, wherein:
the at least one processor is configured to generate the protection key generation information of the UE based on the protection key generation information of the BS, and
the protection key generation information of the UE comprises at least one of a root key, an algorithm type distinguisher indicating a type of the user plane protection key, identification information of an algorithm for generating the protection key, or identification information of the user plane protection key.
